(19) United States
(12) Patent Application Publication
(10) Pub. No.: US 2016/0197950 A1
(43) Pub. Date: Jul. 7, 2016

(54) DETECTION SYSTEM AND METHOD FOR STATICALLY DETECTING APPLICATIONS

(71) Applicant: Rangecloud Information Technology Co., Ltd., New Taipei City (TW)

(72) Inventors: I-TE TSAI, New Taipei City (TW); Ming Hsien Wang, New Taipei City (TW)

(21) Appl. No.: 14/967,927

(22) Filed: Dec. 14, 2015

(30) Foreign Application Priority Data
Jan. 5, 2015 (TW) 104100039

(51) Int. Cl. H04L 29/06

(52) U.S. Cl. CPC H04L 63/1425; H04L 63/0823; H04L 63/0853

(57) ABSTRACT

Disclosed is a method for statically detecting applications, the method including: intercepting, by an acquisition device of the detection system, at least one module file header byte code, at least one module program code and a permission file in an application to be detected which have been complied and encrypted; disassembling and deciphering, by a disassembler and decipher of the detection system, the at least one module file header byte code, the at least one module program code and the permission file which have been complied and encrypted; analyzing, by a verifier of the detection system, the permission file, the at least one module program code and the at least one module file header byte code disassembled and deciphered, to judge whether to perform improper operations on the smart device; and generating, by the verifier, a detection report according to a result of judging whether to perform improper operations on the smart device.

### BACKGROUND

1. Technical Field

The present invention relates to the technical field of computers, and particularly to a detection system and method for statically detecting applications, and a computer program product.

2. Related Art

Smartphones, tablet computers or computers have been one of the smart devices commonly used by people, and in order to meet people's various demands for using the smart devices, lots of applications (apps) are developed to make the smart devices have more functions. However, some applications malicious or neglected by development will do harm to use of the smart devices or steal information inside the smart devices, resulting in that users are worried about use of the smart devices or personal data is stolen.

In order to prevent that the applications malicious or neglected by development will do harm to use of the smart devices or steal data inside the smart devices, detection systems or tools for detecting applications are put forward to perform detection. Currently, detection systems or tools for detecting applications on the market need to use source codes of the applications for detection, a test cannot be carried out if the source codes of the applications are not provided, or the applications may be malicious or neglected although the source codes are provided, and there may be errors between execute files of the applications complied and the original source codes, resulting in that there are errors in detection results; moreover, the manner of manually detecting source codes of the applications requires lots of detection time and manpower for detection, and thus the implementation rate of the detection is not good.

### SUMMARY

In view of the foregoing problems, an objective of the present invention is to provide a detection system and method for statically detecting applications, and a computer program product, which, without providing source codes of the applications, can detect the applications, to detect applications malicious or neglected by development that will do harm to use of smart devices or steal data inside the smart devices, and detecting the applications by the detection system can save detection time and manpower, thus increasing the implementation rate of the detection.

A first aspect of the present invention provides a method for statically detecting applications, the method being implemented by a detection system, and the method including:

intercepting, by an acquisition device of the detection system, at least one module file header byte code, at least one module program code and a permission file in an application to be detected which have been complied and encrypted, wherein the at least one module file header byte code is used to call the corresponding at least one module program code, and the permission file records what functions the application to be detected performs for a smart device;

disassembling and deciphering, by a disassembler and decipher of the detection system, the at least one module file header byte code, the at least one module program code and the permission file which have been complied and encrypted;

analyzing, by a verifier of the detection system, the permission file disassembled and deciphered, to judge whether improper operations performed by the application to be detected on the smart device are recorded;

analyzing, by the verifier, the at least one module program code disassembled and deciphered, to judge whether to perform improper operations on the smart device;

analyzing, by the verifier, the at least one module file header byte code disassembled and deciphered, to judge whether to call the at least one module program code which performs improper operations on the smart device; and

generating, by the verifier, a detection report according to a result of judging whether to perform improper operations on the smart device.

A second aspect of the present invention provides a detection system for statically detecting applications, including:

an acquisition device, which intercepts at least one module file header byte code, at least one module program code and a permission file in an application to be detected which have been complied and encrypted, wherein the at least one module file header byte code is used to call the corresponding at least one module program code, and the permission file records what functions the application to be detected performs for a smart device;

a disassembler and decipher, which disassembles and deciphers the at least one module file header byte code, the at least one module program code and the permission file which have been complied and encrypted; and

a verifier, which analyzes the permission file disassembled and deciphered, to judge whether improper operations performed by the application to be detected on the smart device are recorded, analyzes the at least one module program code disassembled and deciphered, to judge whether to perform improper operations on the smart device, analyzes the at least one module file header byte code disassembled and deciphered, to judge whether to call the at least one module program code which performs improper operations on the smart device, and generates a detection report according to a result of judging whether to perform improper operations on the smart device.

A third aspect of the present invention provides a computer program product with a program stored therein, wherein, after a detection system loads and executes the program, the method according to the first aspect of the present invention can be completed.

The detection system and method for statically detecting applications of the present invention will be described below in detail with reference to the following embodiments, and also as set forth in applicants' Taiwanese priority application no. 104100039, filed on Jan. 5, 2015, the entire contents of which are hereby incorporated herein by reference. However, these embodiments are used mainly to assist in understanding the present invention, but not to restrict the scope of the present invention. Various possible modifications and alterations could be conceived of by one skilled in the art to the form and the content of any particular embodiment, without departing from the spirit and scope of the present invention, which is intended to be defined by the appended claims.

### BRIEF DESCRIPTION OF THE DRAWINGS

FIG. 1 is a block diagram of a detection system for statically detecting applications according to the present invention; and

FIG. 2 is a flowchart of a method for statically detecting applications according to the present invention.

### DETAILED DESCRIPTION

In order to enable those of ordinary skill in the art to further understand the present invention, preferred embodiments of the present invention are listed below to describe constitution contents and effects to be achieved of the present invention in detail in conjunction with the accompanying drawings.

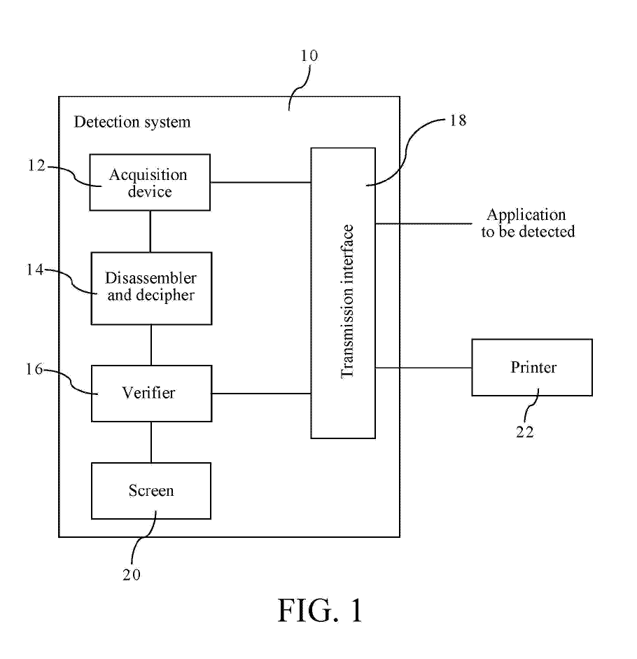

FIG. 1 is a block diagram of a detection system for statically detecting applications according to the present invention. In FIG. 1, a detection system 100 includes an acquisition device 12, a disassembler and decipher 14, a verifier 16, a transmission interface 18 and a screen 20. The detection system 100 is a computer, a server or a cloud, and the application to be detected is an APK file of Android or an IPA file of iOS.

In this embodiment, that the application to be detected is an application applied to Android serves as an example of the present invention, but is not used to limit the application scope of the present invention, and the present invention can be used to detect applications applied to iOS.

The acquisition device 12 receives the application to be detected which has been complied and encrypted via the transmission interface 18, and the application to be detected is an application of an APK file written with Java. Java is a computer programming language, has characteristics of cross-platform, object-oriented and generic programming, and is widely applied to enterprise Web application development and mobile application development.

Java is different from general compiler languages and interpreted languages. It compiles source codes into byte codes at first, then interprets and executes the byte codes according to virtual machines on various different platforms, so as to make a cross-platform characteristics of “write once, execute anywhere”.

The acquisition device 12 intercepts at least one Java bytecode (module file header byte code), at least one Java code (module program code) and a Resource & AndroidManifest.xml (permission file) in an application to be detected which have been complied and encrypted. The at least one Java bytecode is used to call the corresponding at least one Java code, and the Resource & AndroidManifest.xml records what functions the application to be detected performs for a smart device, that is, what functions the application authorized for execution performs for a smart device, for example, the application is executed to read contact data, message data and the like inside the smart device or transmit personal data inside the smart device to an external website (URL, Uniform Resource Locator).

Java bytecode is an instruction format executed by a Java virtual machine, and most operation codes have a length of one byte, while some operations require parameters, resulting in that there are some multi-byte operation codes.

The disassembler and decipher 14 disassembles and deciphers the at least one Java bytecode, the at least one Java code and the Resource & AndroidManifest.xml which have been complied and encrypted, to generate source codes of the at least one Java bytecode and the at least one Java code which have been complied and encrypted and literal contents of the Resource & AndroidManifest.xml, so that analysis can be made on the source codes of the at least one Java bytecode and the at least one Java code and the literal contents of the Resource & AndroidManifest.xml.

The verifier 16 analyzes the literal contents of the Resource & AndroidManifest.xml disassembled and deciphered, to judge whether improper operations performed by the application to be detected on the smart device are recorded, for example, operations such as executing restarting of the smart device and transmitting internal data of the smart device to unknown or illegal websites are performed.

The verifier 16 analyzes the source codes of the at least one Java code disassembled and deciphered, to judge whether the Java code executed performs the improper operations on the smart device. When the verifier 16 analyzes the at least one Java code disassembled and deciphered, the verifier 16 can verify authenticity of a signature or oneness of a certificate in the Java code, to verify validity of the application to be detected.

The verifier 16 analyzes the source codes of the at least one Java bytecode disassembled and deciphered, to judge whether the Java bytecode calls the Java code which performs the improper operations on the smart device.

The verifier 16 generates a detection report according to a result of judging whether to perform improper operations on the smart device. Contents of the detection report can be divided into a dangerous report, for example, execution of the application will make the smart device restarted multiple times; a warning report, for example, a debugging function is not closed, and an external computer can see internal data of the smart device by means of connection; and a reminder report, for example, during execution of the application, the smart device and an external computer (or website) return data therebetween, that is, return data of the number of times.

After the verifier 16 generates the detection report, the screen 20 displays the detection report generated by the verifier 16, or the verifier 16 transmits the detection report to a printer 22 of an external apparatus via the transmission interface 18, and the printer 22 prints the detection report.

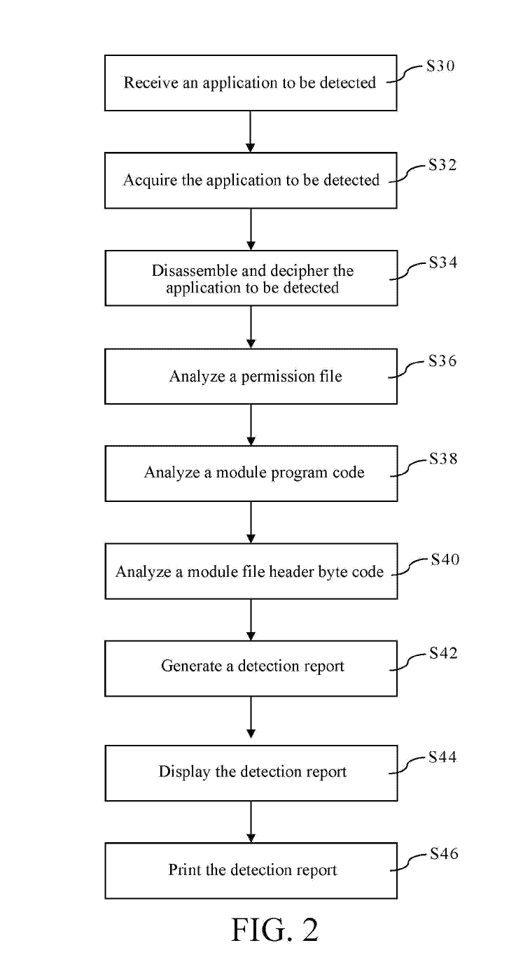

FIG. 2 is a flowchart of a method for statically detecting applications according to the present invention. Reference is made to the components of FIG. 1 when process steps of FIG. 2 are described.

In FIG. 2, the acquisition device 12 receives the application to be detected which has been complied and encrypted via the transmission interface 18, wherein the application to be detected is an application of an APK file written with Java (step S30).

The acquisition device 12 intercepts at least one Java bytecode, at least one Java code and a Resource & AndroidManifest.xml in an application to be detected which have been complied and encrypted. The at least one Java bytecode is used to call the corresponding at least one Java code, and the Resource & AndroidManifest.xml records what functions the application to be detected performs for a smart device, that is, what functions the application authorized for execution performs for a smart device, for example, the application is executed to read contact data, message data and the like inside the smart device or transmit personal data inside the smart device to an external website (step S32).

The disassembler and decipher 14 disassembles and deciphers the at least one Java bytecode, the at least one Java code and the Resource & AndroidManifest.xml which have been complied and encrypted, to generate source codes of the at least one Java bytecode and the at least one Java code which have been complied and encrypted and literal contents of the Resource & AndroidManifest.xml (step S34), so that analysis can be made on the source codes of the at least one Java bytecode and the at least one Java code and the literal contents of the Resource & AndroidManifest.xml.

The verifier 16 analyzes the literal contents of the Resource & AndroidManifest.xml disassembled and deciphered, to judge whether improper operations performed by the application to be detected on the smart device are recorded, for example, operations such as executing restarting of the smart device and transmitting internal data of the smart device to unknown or illegal websites are performed (step S36).

The verifier 16 analyzes the source codes of the at least one Java code disassembled and deciphered, to judge whether the Java code executed performs the improper operations on the smart device (step S38).

For example, http://URL
string “h”;
string “t”;
string “t”;
string “p”;
string “:”;
string “/”;
string “/”;
string “U”;
string “R”;
string “L”;

The above indicates disassembling a word string http://URL, and after combination of the disassembled word string, internal data of the smart device is transmitted to the external website URL.

In the step of analyzing, by the verifier 16, the at least one Java code disassembled and deciphered, the verifier 16 verifies authenticity of a signature or oneness of a certificate in the at least one Java code, to verify validity of the application to be detected.

The verifier 16 analyzes the source codes of the at least one Java bytecode disassembled and deciphered, to judge whether the Java bytecode calls the Java code which performs the improper operations on the smart device (step S40). For example, data (for example, http://URL (unknown or illegal website)) of the improper operations is written in the Java bytecode.

The verifier 16 generates a detection report according to a result of judging whether to perform improper operations on the smart device (step S42). Contents of the detection report can be divided into a dangerous report, for example, execution of the application will make the smart device restarted multiple times; a warning report, for example, a debugging function is not closed, and an external computer can see internal data of the smart device by means of connection; and a reminder report, for example, during execution of the application, the smart device and an external computer (or website) return data therebetween, that is, return data of the number of times.

After the verifier 16 generates the detection report, the screen 20 displays the detection report generated by the verifier 16 (step S44), or the verifier 16 transmits the detection report to a printer 22 of an external apparatus via the transmission interface 18, and the printer 22 prints the detection report (step S46).

The detection system 10 detects the application, and the detection system 10 analyzes source codes of at least one Java bytecode and at least one Java code which have been disassembled and deciphered and literal contents of Resource & AndroidManifest.xml to generate a detection report, and judges according to the detection report whether the application to be detected will do harm to use of smart devices or steal data inside the smart devices, and it is not necessary to judge the source codes of the application manually, so that time and manpower for detecting the application can be saved, thus increasing the implementation rate of the detection.

The method of the present invention can be completed by a computer program product with a program stored therein, and after the detection system downloads and executes the program, for example, from a network, the steps of the method as described above and shown in the figure can be completed.

The present invention provides a detection system and method for statically detecting applications, and a computer program product, and its advantages are as follows: the applications can be detected without provision of source codes of the applications, to detect applications malicious or neglected by development that will do harm to use of smart devices or steal data inside the smart devices, and detecting the applications by the detection system can save detection time and manpower, thus increasing the implementation rate of the detection.

What is claimed is:

1. A method for statically detecting applications, the method being implemented by a detection system, and the method comprising:
intercepting, by an acquisition device of the detection system, at least one module file header byte code, at least one module program code and a permission file in an application to be detected which have been complied and encrypted, wherein the at least one module file header byte code is used to call the corresponding at least one module program code, and the permission file records what functions the application to be detected performs for a smart device;
disassembling and deciphering, by a disassembler and decipher of the detection system, the at least one module file header byte code, the at least one module program code and the permission file which have been complied and encrypted;
analyzing, by a verifier of the detection system, the permission file disassembled and deciphered, to judge whether improper operations performed by the application to be detected on the smart device are recorded;
analyzing, by the verifier, the at least one module program code disassembled and deciphered, to judge whether to perform improper operations on the smart device;
analyzing, by the verifier, the at least one module file header byte code disassembled and deciphered, to judge whether to call the at least one module program code which performs improper operations on the smart device; and
generating, by the verifier, a detection report according to a result of judging whether to perform improper operations on the smart device.

2. The method according to claim 1, wherein the detection system is one of a computer, a server and a cloud, the smart device is one of a smartphone, a tablet computer and a computer, and the application to be detected is an APK file of Android or an IPA file of iOS.

3. The method according to claim 2, wherein the at least one module file header byte code is Java bytecode, the at least one module program code is Java code, and the permission file is Resource & AndroidManifest.xml.

4. The method according to claim 1, wherein, in the step of analyzing, by the verifier, the at least one module program code disassembled and deciphered, authenticity of a signature or oneness of a certificate in the at least one module program code is verified.

5. The method according to claim 1, wherein, before the step of intercepting, by an acquisition device, at least one module file header byte code, at least one module program code and a permission file in an application to be detected which have been complied and encrypted, the acquisition device receives the application to be detected which has been complied and encrypted via a transmission interface of the detection system.

6. The method according to claim 1, wherein, after the step of generating, by the verifier, a detection report according to a result of judging whether to perform improper operations on the smart device, a screen of the detection system displays the detection report, or the verifier transmits the detection report to an external device via a transmission interface of the detection system.

7. A detection system for statically detecting applications, comprising:
an acquisition device, which intercepts at least one module file header byte code, at least one module program code and a permission file in an application to be detected which have been complied and encrypted, wherein the at least one module file header byte code is used to call the corresponding at least one module program code, and the permission file records what functions the application to be detected performs for a smart device;
a disassembler and decipher, which disassembles and deciphers the at least one module file header byte code, the at least one module program code and the permission file which have been complied and encrypted; and
a verifier, which analyzes the permission file disassembled and deciphered, to judge whether improper operations performed by the application to be detected on the smart device are recorded, analyzes the at least one module program code disassembled and deciphered, to judge whether to perform improper operations on the smart device, analyzes the at least one module file header byte code disassembled and deciphered, to judge whether to call the at least one module program code which performs improper operations on the smart device, and generates a detection report according to a result of judging whether to perform improper operations on the smart device.

8. The detection system according to claim 7, wherein the detection system is one of a computer, a server and a cloud, the smart device is one of a smartphone, a tablet computer and a computer, and the application to be detected is an APK file of Android or an IPA file of iOS.

9. The detection system according to claim 8, wherein the at least one module file header byte code is Java bytecode, the at least one module program code is Java code, and the permission file is Resource & AndroidManifest.xml.

10. The detection system according to claim 7, wherein, when the verifier analyzes the at least one module program code disassembled and deciphered, the verifier verifies authenticity of a signature or oneness of a certificate in the at least one module program code.

11. The detection system according to claim 7, further comprising:
a transmission interface, wherein the acquisition device receives the application to be detected which has been complied and encrypted via the transmission interface, and the verifier transmits the detection report to an external device via the transmission interface; and
a screen, which displays the detection report.
